(19) United States
(12) Patent Application Publication
(10) Pub. No.: US 2025/0378172 A1
(43) Pub. Date: Dec. 11, 2025

(54) CYBERSECURITY STANDARDS CONTROLS COMPLIANCE EVIDENCE ANALYSIS ENGINE

(71) Applicant: SAUDI ARABIAN OIL COMPANY, Dhahran (SA)

(72) Inventors: Jamal M. Abbad, Dammam (SA); Tariq O. Maghrabi, Dammam (SA); Hussain T. Alattas, Dhahran (SA); Maha A. Aldhamadi, Dhahran (SA)

(73) Assignee: SAUDI ARABIAN OIL COMPANY, Dhahran (SA)

(21) Appl. No.: 18/737,809

(22) Filed: Jun. 7, 2024

(51) Int. Cl. G06F 21/57

(52) U.S. Cl. CPC G06F 21/577

(57) ABSTRACT

A method and a system for assessing the compliance of continuous cybersecurity data security of infrastructure, endpoints, and other organization aspects. The method may include obtaining image data from a data repository and performing, by a computer processor, a similarity comparison of the obtained image data using a plurality of comparison techniques. Further, the method includes extracting cybersecurity data from the obtained image data and preprocessing the cybersecurity data using at least one preprocessing technique. A first assessment of the preprocessed cybersecurity data is generated using regular expression analysis and a second assessment of the preprocessed cybersecurity data is generated using a plurality of machine learning models. A cybersecurity compliance score is computed based on the first assessment and the second assessment and a remediation command configured to adjust at least one configuration setting of a network is transmitted.

### BACKGROUND

Cybersecurity may include the protection of an organization's data and/or infrastructure from both outside threats and individuals within an organization that may compromise the data, cause a denial of service, or other sort of attacks. Automating the process of evaluating and tracking cybersecurity compliance levels for organizations, eliminates the need for extensive human interventions, ensuring the accuracy and consistency of compliance assessments. Accordingly, it is commonly needed among many organizations to continuously benchmark their cybersecurity state against an international or customized standard or framework to identify how compliant their cybersecurity state is, how much they are in compliance with recommended practices and where the areas of improvement are.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method. The method includes obtaining image data from a data repository and performing, by a computer processor, a similarity comparison of the obtained image data using a plurality of comparison techniques. Further, the method includes extracting cybersecurity data from the obtained image data and preprocessing the cybersecurity data using at least one preprocessing technique. A first assessment of the preprocessed cybersecurity data is generated using regular expression analysis and a second assessment of the preprocessed cybersecurity data is generated using a plurality of machine learning models. A cybersecurity compliance score is computed based on the first assessment and the second assessment and a remediation command configured to adjust at least one configuration setting of a network is transmitted.

In general, in one aspect, embodiments disclosed herein relate to a system including a network comprising a plurality of network elements, a hardware probe coupled to the plurality of network elements, a network element coupled to the plurality of network elements, the network element comprising a software probe, and a computer processor, wherein the computer processor is coupled to the hardware probe, the software probe, and the plurality of network elements. Further, the computer processor comprises functionality for obtaining image data from a data repository and performing a similarity comparison of the obtained image data using a plurality of comparison techniques. Additionally, the computer processor comprises functionality for extracting cybersecurity data from the obtained image data and preprocessing the cybersecurity data using at least one preprocessing technique. A first assessment of the preprocessed cybersecurity data is generated using regular expression analysis and a second assessment of the preprocessed cybersecurity data is generated using a plurality of machine learning models. A cybersecurity compliance score is computed based on the first assessment and the second assessment and a remediation command configured to adjust at least one configuration setting of a network is transmitted.

In general, in one aspect, embodiments disclosed herein relate to a non-transitory computer readable medium storing a set of instructions executable by a computer processor. The set of instructions include the functionality for obtaining image data from a data repository and performing a similarity comparison of the obtained image data using a plurality of comparison techniques. Further, the set of instructions include the functionality for extracting cybersecurity data from the obtained image data and preprocessing the cybersecurity data using at least one preprocessing technique. A first assessment of the preprocessed cybersecurity data is generated using regular expression analysis and a second assessment of the preprocessed cybersecurity data is generated using a plurality of machine learning models. A cybersecurity compliance score is computed based on the first assessment and the second assessment and a remediation command configured to adjust at least one configuration setting of a network is transmitted.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1 shows a system in accordance with one or more embodiments.

FIG. 2 shows a flowchart in accordance with one or more embodiments.

FIG. 3 shows a neural network in accordance with one or more embodiments.

FIG. 4 shows a flowchart in accordance with one or more embodiments.

FIG. 5 shows a flowchart in accordance with one or more embodiments.

FIG. 6 shows a computing system in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

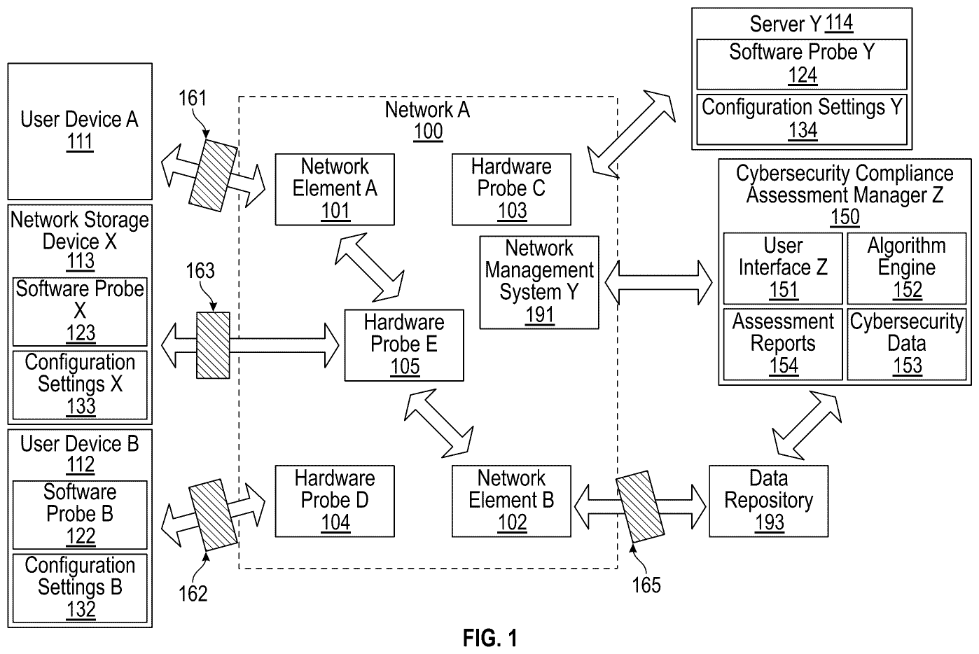

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein provide a method and system for assessing the compliance of continuous cybersecurity data security of infrastructure, endpoints, and other organization aspects. The method offers an automated and centralized system for assessing the compliance level of all departments within an organization against common standards and controls. The system employs a combination of cutting-edge technologies, including machine learning algorithms, regular expression analysis (regex), and image text extraction, to streamline the compliance assessment process.

Further, the infrastructure may include communication infrastructure (such as cellular wireless network links or leased lines or satellite links), network infrastructure (such as switches, routers and links between them), computing infrastructure (such as servers and storage devices that include premise-based or cloud-based devices), and/or cybersecurity infrastructure (such as Firewalls, IDS, IPS, etc.). The endpoints may include user devices (e.g., PCs, mobile devices) or peripherals. Other organizational aspects may include the availability of approved cybersecurity strategies, policies, procedures and workforce certifications. For brevity, “infrastructure and endpoints” (or “network or organization”) may be used hereinafter to imply the holistic scope mentioned above.

Furthermore, the method of embodiments disclosed herein monitors the activity of the infrastructure and endpoints and generates the compliance report or specific events that may be critical for the cybersecurity of the entire network. To perform a cybersecurity compliance monitoring and assurance, multiple hardware probes and multiple software probes may be disposed around a network in order to collect data for analyzing cybersecurity risks as well as detect changes to the cybersecurity state of the network. For example, hardware probes may monitor inline network traffic as the data passes through particular nodes along a network path. On the other hand, software probes may be installed on various network elements to monitor configuration settings and other system data in order to provide a security picture of the infrastructure system or endpoints in a network. More specifically, a cybersecurity compliance assessment may use one or more activity assessment models that provide a metric for analyzing specific cybersecurity areas of an organization as well as for determining an overall cybersecurity picture of the organization against one or more cybersecurity standards or frameworks. One or more embodiments include a cybersecurity compliance assessment manager that provides an autonomous process that determines cybersecurity compliance scores and compliance with security standards.

This method eliminates the need for extensive human interventions, ensuring the accuracy and consistency of compliance assessments. One of the key benefits of this disclosure is eradicating subjectivity in the evaluation process, which often arises when assessors possess varying levels of competency. The automated system ensures that the assessment is carried out objectively and impartially, leading to more reliable results than a manual assessment. Moreover, the invention described herein significantly reduces the duration, time, and overall cost associated with compliance assessments. Traditional assessments can be time-consuming and expensive due to manual processes and the need for on-site visits. However, with the automated disclosed embodiments, enterprises can conduct assessments more frequently, even in real-time, allowing them to keep a constant measure of their cybersecurity compliance level. The versatility of the invention is another crucial aspect. It can be deployed either on-premises or as a cloud service, offering flexibility to organizations based on their specific needs. This deployment flexibility further reduces deployment complexity, implementation time, and assessment costs.

This disclosure addresses the challenge of automating compliance evaluations against both widely accepted common standards and local controls and offers a comprehensive system that comprises multiple interconnected components, each contributing to the efficiency and accuracy of the compliance assessment process. Additionally, this method streamlines the evaluation of cybersecurity standard controls in organizations, facilitating the assessment against various standards, including widely recognized ones and customized local controls. By automating this process, the system reduces the burden on organizations, saving valuable time and resources.

Additionally, this disclosure introduces a powerful web application platform designed to be hosted within an organization's internal network, enabling seamless and consistent cybersecurity assessments across all departments. The method eliminates subjectivity in the assessment process and provides assessors with a comprehensive set of functionalities that optimize efficiency and minimize time-consuming tasks. Each individual component and function of the web application is meticulously designed to enhance the assessment experience, ensuring the best possible outcomes

Further, the automated process for cybersecurity compliance assessments offers substantial time and cost savings. Currently, each assessment typically takes about 1 month to complete. This timeframe includes various manual tasks such as data gathering, analysis, and reporting, all of which require skilled professionals to dedicate their time. By implementing this automated process, we anticipate a significant reduction in assessment time. Leveraging advanced algorithms and machine learning capabilities, our system streamlines the assessment process, automating many manual tasks and accelerating the overall workflow.

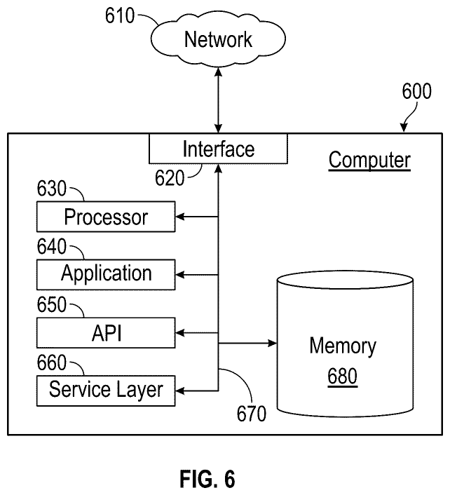

Turning to FIG. 1, FIG. 1 shows a schematic diagram in accordance with one or more embodiments. As shown in FIG. 1, a network (e.g., network A (100)) may be coupled to various user devices (e.g., user device A (111), user device B (112)), one or more servers (e.g., server Y (114)), a network storage device (e.g., network storage device X (113)), various network elements (e.g., network element A (101), network element B (102)). A network element may refer to various hardware components within a network, such as switches, routers, and hubs, as well as user devices, servers, network storage devices, user equipment, or any other logical entities for uniting one or more physical devices on the network. User devices may include personal computers, smartphones, human machine interfaces, and any other devices coupled to a network that obtain inputs from one or more users. In some embodiments, a network includes a cybersecurity compliance assessment manager (e.g., cybersecurity compliance assessment manager Z (150)). The cybersecurity compliance assessment manager Z (150) includes hardware and/or software that includes functionality for determining cybersecurity risks and/or remediating the cybersecurity risks, such as restarting network devices, performing connection tests, and implementing security protocols, etc. In some embodiments, a cybersecurity compliance assessment manager, network elements, user equipment, user devices, servers, and/or a network storage device may be computing systems similar to the computing system (600) described in FIG. 6, and the accompanying description.

In some embodiments, a network includes a log system that obtains cybersecurity data using hardware probes (103-105), software probes (122-124), and the network management system (191). The log system obtains data from operating systems, firewalls, proxy, routers, modems, etc. These data sources are the sources from which cybersecurity data discussed herein is monitored/collected. As such, networks include one or more hardware probes (e.g., hardware probe C (103), hardware probe D (104), hardware probe E (105)). In particular, a hardware probe may include hardware that has functionality to monitor inline data transmissions, such as data sent between endpoints communicating over network paths or data sent between network elements as shown in hardware probe E (105). For example, hardware probe D (104) may perform a packet analysis on network data (162) that is transmitted by user device B (112) to server Y (114) to determine one or more security vulnerabilities or noncompliance with one or more security protocols. Thus, various hardware probes may collect network information regarding security control implementations, security protocols, and other types of security information directly from network traffic. Hardware probes may further transmit such network information (e.g., network information D (165) to a cybersecurity compliance assessment manager for further analysis.

In some embodiments, for example, the cybersecurity compliance assessment manager Z (150) includes functionality for receiving information from a data repository (193) containing configuration information regarding all network elements including information about the activity of the network elements. As such, a hardware probe may include hardware that performs a packet analysis to identify and categorize inbound and outbound running applications by monitoring network traffic. Thus, hardware probes determine a presence and/or violation of one or more security metrics through a packet analysis. In some embodiments, for example, a hardware probe detects any activity within a network element and transmits the information regarding the activity and the network element to the data repository (193). Thus, hardware probes may identify devices within a network and their respective cybersecurity risks based on analyzing network traffic.

In some embodiments, a network (e.g., network A (100)) includes one or more software probes. For example, a software probe may be software installed on a network element (e.g., software probe X (123), software probe B (122) on user device B (112), software probe Y (124)) for monitoring potential security vulnerabilities associated with the network element. For example, a software probe may include functionality to identify various configuration settings (e.g., configuration settings B (132), configuration settings X (133), configuration settings Y (134)), such as security controls, network communication settings, and/or various security protocols performed using the network element. In some embodiments, a software probe may compare configuration settings to one or more predetermined security policies, security controls, and/or baselines to identify compliance issues and other security vulnerabilities.

Returning to the cybersecurity compliance assessment manager, the cybersecurity compliance assessment manager Z (150) may include hardware and/or software that includes functionality for collecting cybersecurity data (e.g., cybersecurity data (153)) over a network using various hardware probes and software probes. In some embodiments, the cybersecurity compliance assessment manager obtains cybersecurity data by interfacing and extracting information from other management systems in a network or among an organization's infrastructure. In particular, the cybersecurity compliance assessment manager Z (150) may request information from a Data Repository (193), and a network management system (e.g., network management system Y (191)). In some embodiments, the cybersecurity compliance assessment manager Z (150) is implemented in a cloud computing environment by a cloud server, where the cloud server may obtain the data from various probes over various internet connections. Where cybersecurity data may be generated by a cybersecurity compliance assessment manager, in some embodiments, hardware probes and/or software probes may directly generate the cybersecurity data.

In some embodiments, the cybersecurity compliance assessment manager Z (150) obtains user inputs from one or more user devices regarding activity of the network device, network interface card type, reservation status, switch port, asset details, or last scan time, physical location or the system name of the network element currently using the network. In some embodiments, a cybersecurity compliance assessment manager includes hardware and/or software such as an algorithm engine (152) for analyzing data received from the network management system (191), and the Data Repository (193). This activity and availability assessment of the network elements may be based on one or more templates corresponding to a security standard or framework.

In some embodiments, the cybersecurity compliance assessment manager Z (150) includes functionality for transmitting one or more remediation commands (e.g., remediation command (163)) based on one or more activity and availability assessment of the network elements. In particular, a remediation command may be a network message that causes one or more remediation procedures to be performed automatically by a network element. Examples of remediation procedures may include one or more of the following: performing connection tests to validate availability of the network element; changing configuration settings on a network element; removing a network connection; or adjusting a predetermined workflow or rule associated with a network protocol. In some embodiments, the cybersecurity compliance assessment manager Z (150) includes a remediation queue that organizes the sequence that remediation procedures are implemented in a network. For example, a remediation action may be increasing level of logging and monitoring for systems that show signs of suspicious activity to gather more data for analysis.

In some embodiments, the cybersecurity compliance assessment manager Z (150) includes hardware and/or software that provides a user interface (e.g., user interface Z (151)) to various user devices over a network or in a cloud computing environment. In particular, the user interface may provide parties with the capability to review the activity and availability assessment regarding network elements or an organization as a whole. Likewise, a user interface may receive inputs from a user, such as cybersecurity analysts, regarding cybersecurity risks and security protocols. In some embodiments, for example, a cybersecurity compliance assessment manager may include software to provide a graphical user interface for presenting data and/or receiving commands to initiate remediation actions with a network.

Keeping with FIG. 1, the cybersecurity compliance assessment manager Z (150) may include functionality for generating one or more assessment reports (e.g., assessment report M (161), assessment reports (154)) based on cybersecurity data. In particular, an assessment report may include the compliance metric of various elements and alert the administrator to investigate and fix the issue. In some embodiments, an assessment report includes changes in the network with respect to a particular measurement from a previous report.

Furthermore, an assessment report may indicate changes with respect to an overall cybersecurity assessment for a network or organization. Reports may also include updates regarding performance of current remediation procedures. Likewise, a cybersecurity compliance assessment manager may store previous assessment reports (e.g., assessment reports (154) in a database, such as to compare and identify overall performance improvements at periodic intervals. Such assessment reports may be provided to user devices through a dashboard integration to a cybersecurity compliance assessment manager's user interface.

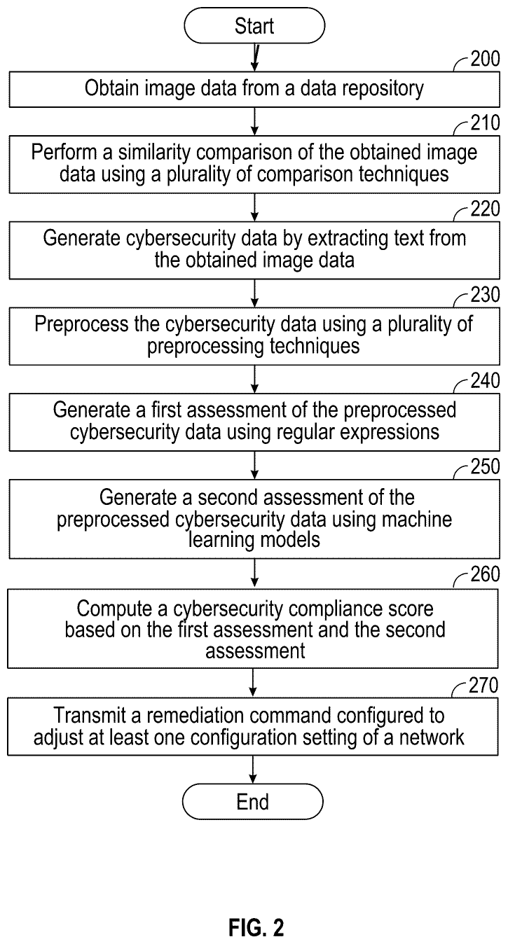

Turning to FIG. 2, FIG. 2 shows a flowchart in accordance with one or more embodiments. Specifically, FIG. 2 describes a general method for assessing the compliance of the cybersecurity data. One or more blocks in FIG. 2 may be performed by one or more components (e.g., cybersecurity compliance assessment manager (150)) as described in FIG. 1. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 200, image data is obtained in accordance with one or more embodiments. The image data is stored in data repository (193) and may include various picture and video formats. The image data serves as a visual proof of documentation. The visual proof of documentation may include images and videos documenting compliance with the regulations, standards, and guidelines. Further, the image data may include screenshots of safety procedure results, equipment inspection, checklists, etc. The image data may be periodically automatically collected by hardware and software probes. Additionally, the image data may be uploaded to the data repository by a cybersecurity system operator after completing a task or when evaluating a compliance of a part of the system or system in general.

In Block 210, the cybersecurity compliance assessment manager (150) generates a similarity comparison using a plurality of comparison techniques. Ensuring the integrity and prevention of cheating in the assessment process is enabled by a comprehensive and reliable compliance evaluation. To address this, the system incorporates robust similarity checking mechanisms that compare new assessments against existing ones in the database. By leveraging the database's stored evidence and assessment data, the system may effectively detect any potential discrepancies or attempts to use other department's evidence. In some embodiments, the comparison may include, at least, a hash comparison and/or a pixel comparison.

In one or more embodiments, the hash comparison is used to detect potential duplicate or reused evidence. Specifically, when a new department submits evidence for a specific control, the system generates a unique cryptographic hash for each uploaded evidence. The cryptographic hash acts as a digital fingerprint for the evidence, representing its unique characteristics. The system then compares the newly generated cryptographic hashes against the existing hashes of evidence previously submitted by other departments for the same control. If any matches are found, it indicates that the same evidence has been previously submitted, raising a flag for further investigation. This approach efficiently detects attempts to use identical or similar evidence across different departments.

In one or more embodiments, additionally to hash comparison, the system incorporates pixel-level comparison for image-based evidence. Specifically, each image submitted by a department is analyzed at the pixel level, enabling the system to determine its unique visual features. The system sets specific thresholds for each control, defining acceptable visual similarities based on the nature of the assessment. If the image provided by a department exceeds the threshold for similarity with other previously submitted images for the same control, the system triggers an alert, indicating potential reuse or unauthorized sharing of evidence.

By combining hash comparison and pixel-level analysis, the system offers a comprehensive similarity checking system that safeguards the assessment process from manipulation and ensures the integrity of compliance evaluations. The combination enables the assessors to trust the system to detect any attempts to use misleading evidence, ensuring a fair and accurate assessment for each department.

In Block 220, the algorithm engine (152) analyzes the image data stored in the data repository (193). More specifically, the algorithm engine (152), initially, processes the image data to extract the cybersecurity data. In one or more embodiments, the cybersecurity data may be in form of a text (e.g., logs, reports, emails, etc.), numeric data (e.g., network traffic, bandwidth usage, number of logged in users, performance metrics, etc.), metadata (e.g., timestamps, file attributes, IP addresses, etc.), binary data, structured data, and/or unstructured data.

In one or more embodiments, the cybersecurity data is extracted from the image data by the algorithm engine (152) using one or more cybersecurity data extraction functions. In some embodiments, the cybersecurity data extraction functions may include optical character recognition, image processing, machine learning, the template matching, handwriting recognition, barcodes, and QR codes. More specifically, the extraction functions may analyze printed text, handwritten texts, text embedded within images, templates, checklists, numerical data, etc.

In Block 230, the algorithm engine (152) preprocesses the extracted cybersecurity data using one or more preprocessing techniques. The preprocessing techniques may include, at least, noisy entity removal, tokenization, and lemmatization. The noise entity removal enhances the quality of extracted text by removing noisy entities such as stop words (e.g., “the,” “is,” “in,” “end,” etc.), whitespaces, punctuation, misspelled words, and non-alphanumeric characters. More specifically, the noisy entities are words that do not carry significant meaning in the text analysis.

Further, in some embodiments, the tokenization is a process of segmentizing the text into smaller units (“tokens”). The tokens may represent any organized text unit including paragraphs, sentences, phrases, words, etc. The tokenization may be predetermined based on a specific task or application of the tokens. Additionally, lemmatization is a process of reducing words to their base form (“lemma”) or root of the word. The tokenization and lemmatization process are used to enhance data by reducing a redundancy of words, improving interpretability, and preparing a text for further analysis. Further, the preprocessed words are stored in the data repository for future reference and utilization.

In Block 240, the cybersecurity compliance assessment manager (150) generates a first assessment of the preprocessed cybersecurity data using a regular expression analysis. The regular expression analysis includes searching for patterns or sequences of characters or numbers within a text. The regular expression analysis may be used to define text patterns that are searched for in emails, documents, webpages, etc. When the regular expression analysis finds required patterns, the patterns may be validated according to predetermined formulas to ensure matching formats of data.

In one or more embodiments, the first assessment of the preprocessed cybersecurity data using a regular expression analysis generates the pattern matches within the cybersecurity data, such as specific sequences of characters, keywords, or numeric values. Further, the first assessment generates compliance indicators that highlight compliance with predefined security controls based on the presence or absence of certain patterns. Additionally, anomaly detections that flag or alert for anomalies or deviations from expected patterns, suggesting potential security issues may be detected. The data generated by the first assessment is stored in the data repository and used as the input in Block 250.

In Block 250, the cybersecurity compliance assessment manager (150) generates a second assessment of the preprocessed cybersecurity data using one or more machine learning models. The machine learning models use the patterns generated through the regular expression analysis. The machine learning models may be specifically trained on relevant datasets to recognize patterns, relationships, and context within the extracted text. By leveraging machine learning the patterns that demand a deeper understanding of context and variations may be effectively evaluated.

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a machine-learned model is referred to as selecting the model “architecture.” Once a machine-learned model type and hyperparameters have been selected, the machine-learned model is trained to perform a task.

Herein, a cursory introduction to various machine-learned models such as a neural network (NN) and convolutional neural network (CNN) are provided as these models are often used as components—or may be adapted and/or built upon—to form more complex models such as autoencoders and diffusion models. However, it is noted that many variations of neural networks, convolutional neural networks, autoencoders, transformers, and diffusion models exist. Therefore, one with ordinary skill in the art will recognize that any variations to the machine-learned models that differ from the introductory models discussed herein may be employed without departing from the scope of this disclosure. Further, it is emphasized that the following discussions of machine-learned models are basic summaries and should not be considered limiting.

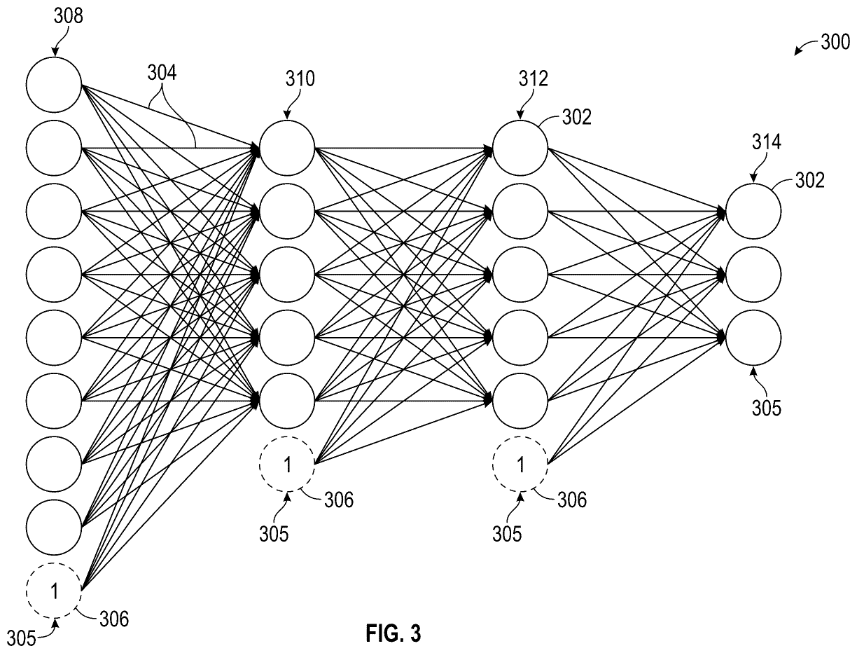

A diagram of a neural network is shown in FIG. 3. At a high level, a neural network (300) may be graphically depicted as being composed of nodes (302), where any circle represents a node, and edges (302), shown here as directed lines. The nodes (302) may be grouped to form layers (305). FIG. 3 displays four layers (308, 310, 312, 314) of nodes (302) where the nodes (302) are grouped into columns, however, the grouping need not be as shown in FIG. 3. The edges (302) connect the nodes (302). Edges (302) may connect, or not connect, to any node(s) (302) regardless of which layer (305) the node(s) (302) is in. That is, the nodes (302) may be sparsely and residually connected. A neural network (300) will have at least two layers (305), where the first layer (308) is considered the “input layer” and the last layer (314) is the “output layer.” Any intermediate layer (310, 312) is usually described as a “hidden layer.” A neural network (300) may have zero or more hidden layers (310, 312) and a neural network (300) with at least one hidden layer (310, 312) may be described as a “deep” neural network or as a “deep learning method.” In general, a neural network (300) may have more than one node (302) in the output layer (314). In this case the neural network (300) may be referred to as a “multi-target” or “multi-output” network.

Nodes (302) and edges (302) carry additional associations. Namely, every edge is associated with a numerical value. The edge numerical values, or even the edges (302) themselves, are often referred to as “weights” or “parameters.” While training a neural network (300), numerical values are assigned to each edge (302). Additionally, every node (302) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad ( 2 )$$

where i is an index that spans the set of “incoming” nodes (302) and edges (302) and f is a user-defined function. Incoming nodes (302) are those that, when viewed as a graph (as in FIG. 3), have directed arrows that point to the node (302) where the numerical value is being computed. Some functions for f may include the linear function f(x)=x, sigmoid function

$$f ( x ) = \frac{1}{1 + {e}^{- x}} ,$$

and rectified linear unit function f(x)=max(0, x), however, many additional functions are commonly employed. Every node (302) in a neural network (300) may have a different associated activation function. Often, as a shorthand, activation functions are described by the function f by which it is composed. That is, an activation function composed of a linear function f may simply be referred to as a linear activation function without undue ambiguity.

When the neural network (300) receives an input, the input is propagated through the network according to the activation functions and incoming node (302) values and edge (302) values to compute a value for each node (302). That is, the numerical value for each node (302) may change for each received input. Occasionally, nodes (302) are assigned fixed numerical values, such as the value of 1, that are not affected by the input or altered according to edge (302) values and activation functions. Fixed nodes (302) are often referred to as “biases” or “bias nodes” (306), displayed in FIG. 3 with a dashed circle.

In some implementations, the neural network (300) may contain specialized layers (305), such as a normalization layer, or additional connection procedures, like concatenation. One skilled in the art will appreciate that these alterations do not exceed the scope of this disclosure.

As noted, the training procedure for the neural network (300) comprises assigning values to the edges (304). To begin training the edges (304) are assigned initial values. These values may be assigned randomly, assigned according to a prescribed distribution, assigned manually, or by some other assignment mechanism. Once edge (304) values have been initialized, the neural network (300) may act as a function, such that it may receive inputs and produce an output. As such, at least one input is propagated through the neural network (300) to produce an output. Training data is provided to the neural network (300). Generally, training data consists of pairs of inputs and associated targets. The targets represent the “ground truth,” or the otherwise desired output, upon processing the inputs. During training, the neural network (300) processes at least one input from the training data and produces at least one output. Each neural network (300) output is compared to its associated input data target. The comparison of the neural network (300) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (300) output and the associated target. The loss function may also be constructed to impose additional constraints on the values assumed by the edges (304), for example, by adding a penalty term, which may be physics-based, or a regularization term. Generally, the goal of a training procedure is to alter the edge (304) values to promote similarity between the neural network (300) output and associated target over the training data. Thus, the loss function is used to guide changes made to the edge (304) values, typically through a process called “backpropagation.”

While a full review of the backpropagation process exceeds the scope of this disclosure, a brief summary is provided. Backpropagation consists of computing the gradient of the loss function over the edge (304) values. The gradient indicates the direction of change in the edge (304) values that results in the greatest change to the loss function. Because the gradient is local to the current edge (304) values, the edge (304) values are typically updated by a “step” in the direction indicated by the gradient. The step size is often referred to as the “learning rate” and need not remain fixed during the training process. Additionally, the step size and direction may be informed by previously seen edge (304) values or previously computed gradients. Such methods for determining the step direction are usually referred to as “momentum” based methods.

Once the edge (304) values have been updated, or altered from their initial values, through a backpropagation step, the neural network (300) will likely produce different outputs. Thus, the procedure of propagating at least one input through the neural network (300), comparing the neural network (300) output with the associated target with a loss function, computing the gradient of the loss function with respect to the edge (304) values, and updating the edge (304) values with a step guided by the gradient, is repeated until a termination criterion is reached. Common termination criteria are reaching a fixed number of edge (304) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (304) values are no longer intended to be altered, the neural network (300) is said to be “trained.”

One or more embodiments disclosed herein employ a convolutional neural network (CNN). A CNN is similar to a neural network (300) in that it can technically be graphically represented by a series of edges (304) and nodes (302) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Grid data, which may be three-dimensional, has such a structural relationship because each data element, or grid point, in the grid data has a spatial location (and sometimes also a temporal location when grid data is allowed to change with time). Consequently, a CNN is an intuitive choice for processing grid data.

A structural grouping, or group, of weights is herein referred to as a “filter”. The number of weights in a filter is typically much less than the number of inputs, where here the number of inputs refers to the number of data elements or grid points in a set of grid data. In a CNN, the filters can be thought as “sliding” over, or convolving with, the inputs to form an intermediate output or intermediate representation of the inputs which still possesses a structural relationship. Like the neural network (300), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (300) to produce a final output. Note, that in this context, the neural network (300) is still considered part of the CNN. Like a neural network (300), a CNN is trained, after initialization of the filter weights, and the edge (304) values of the internal neural network (300), if present, with the backpropagation process in accordance with a loss function.

A common architecture for CNNs is the so-called “U-net.” The term U-net is derived because a CNN after this architecture is composed of an encoder branch and a decoder branch that, when depicted graphically, often form the shape of the letter “U.” Generally, in a U-net type CNN the encoder branch is composed of N encoder blocks and the decoder branch is composed of N decoder blocks, where N≥1. The value of N may be considered a hyperparameter that can be prescribed by user or learned (or tuned) during a training and validation procedure. Typically, each encoder block and each decoder block consist of a convolutional operation, followed by an activation function and the application of a pooling (i.e., downsampling) or upsampling operation. Further, in a U-net type CNN each of the N encoder and decoder blocks may be said to form a pair. Intermediate data representations output by an encoder block may be passed to, and often concatenated with other data, an associated (i.e., paired) decoder block through a “skip” connection or “residual” connection.

Another type of machine-learned model is a transformer. A detailed description of a transformer exceeds the scope of this disclosure. However, in summary, a transformer may be said to be deep neural network capable of learning context among data features. Generally, transformers act on sequential data (such as a sentence where the words form an ordered sequence). Transformers often determine or track the relative importance of features in input and output (or target) data through a mechanism known as “attention.” In some instances, attention mechanism may further be specified as “self-attention” and “cross-attention,” where self-attention determines the importance of features of a data set (e.g., input data, intermediate data) relative to other features of the data set. For example, if the data set is formatted as a vector with M elements, then self-attention quantifies a relationship between the M elements. In contrast, cross-attention determines the relative importance of features to each other between two data sets (e.g., an input vector and an output vector). Although transformers generally operate on sequential data composed of ordered elements, transformers do not process the elements of the data sequentially (such as in a recurrent neural network) and require an additional mechanism to capture the order, or relative positions, of data elements in a given sequence. Thus, transformers often use a positional encoder to describe the position of each data element in a sequence, where the positional encoder assigns a unique identifier to each position. A positional encoder may be used to describe a temporal relationship between data elements (i.e., time series) or between iterations of a data set when a data set is processed iteratively (i.e., representations of a data set at different iterations). While concepts such as attention and positional encoding were generally developed in the context of a transformer, they may be readily inserted into—and used with—other types of machine-learned models (e.g., diffusion models).

Turning to reinforcement learning, a simulator may perform one or more reinforcement learning algorithms using a reinforcement learning system to train a machine-learning model. In particular, a reinforcement learning algorithm may be a type of method that autonomously learns agent policies through multiple iterations of trials and evaluations based on observation data. The objective of a reinforcement learning algorithm may be to learn an agent policy π that maps one or more states of an environment to an action so as to maximize an expected reward J(π). A value reward may describe one or more qualities of a particular state, agent action, and/or trajectory at particular time within an operation, such as an electric power generation operation. As such, a reinforcement learning system may include hardware and/or software with functionality for implementing one or more reinforcement learning algorithms. For example, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agent interactions with a complex environment, such as a geological subsurface with various geological interfaces and different formations. As such, a reinforcement learning algorithm may include a reward function that teaches a particular action selection engine to follow certain rules, while still allowing the reinforcement learning model to retain information learned from previous simulations.

In some embodiments, one or more components in a reinforcement learning system are trained using a training system. For example, an agent policy and/or a reward function may be updated through a training process that is performed by a machine-learning algorithm. In some embodiments, historical data, augmented data, and/or synthetic data may provide a supervised signal for training an action selector engine, an agent policy, and/or a reward function, such as through an imitation learning algorithm. In another embodiment, an interactive expert may provide data for adjusting agent policies and/or reward functions.

In one or more embodiments, an imitation learning model, which is part of the reinforced learning models, may be a preferred machine learning model. The imitation learning model instead of trying to learn from the sparse rewards or manually specifying a reward function, an expert (e.g., operator) provides the model with a set of demonstrations. The agent then tries to learn the optimal policy by imitating the expert's decisions. The main component of the imitation learning model is the environment, which is essentially a Markov Decision Process (MDP). Specifically, the environment has an S set of states, an A set of actions, a P(s′|s, a) transition model, describing a probability that an action a in the state s leads to state s′, and an unknown R(s, a) reward function. The agent performs different actions in this environment based on its π policy. Finally, the loss function and the learning algorithm are two main components, in which the various imitation learning methods differ from each other.

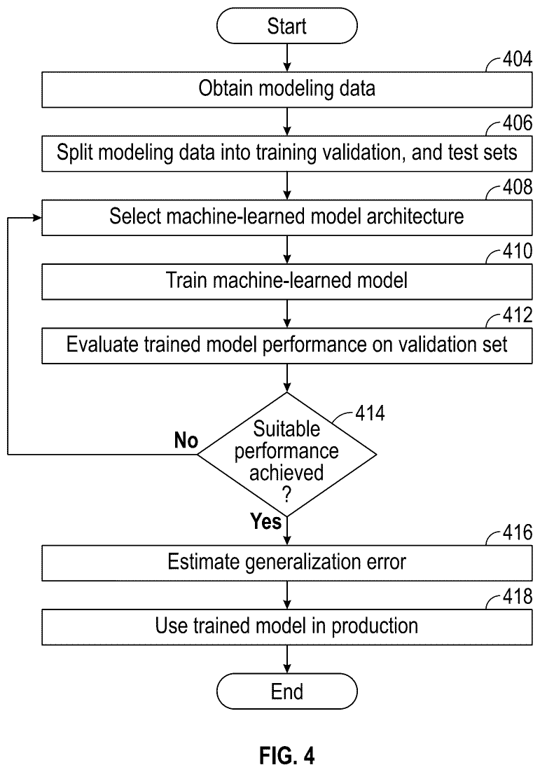

FIG. 4 depicts a general framework for training and evaluating a machine-learned model. Herein, when training a machine-learned model, the more general term “modeling data” will be adopted as opposed to training data to refer to data used for training, evaluating, and testing a machine-learned model. Further, use of the term modeling data prevents ambiguity when discussing various partitions of modeling data such as a training set, validation set, and test set, described below. In the context of FIG. 4, modeling data will be said to consist of pairs of inputs and associated targets. When a machine-learned model is trained using pairs of inputs and associated targets, that machine-learned model is typically categorized as a “supervised” machine-learned model or a supervised method. In the literature, autoencoders are often categorized as “unsupervised” or “semi-supervised” machine learning models because modeling data used to train these models does not include distinct targets. For example, in the case of autoencoders, the output, and thus the desired target, of an autoencoder is the input. That said, while autoencoders may not be considered supervised models, the training procedure depicted in FIG. 4 may still be applied to train autoencoders where it is understood that an input-target pair is formed by setting the target equal to the input.

To train a machine-learned model, modeling data must be provided. In accordance with one or more embodiments, modeling data may be collected from existing image data. Further, the cybersecurity data about the image data such may be supplied to the machine-learning model. In one or more embodiments, modeling data is synthetically generated. This is to promote robustness in the machine-learned model, such that it is generalizable to new environments, components and input data unseen during training and evaluation.

Keeping with FIG. 4, in Block 404, modeling data is obtained. As stated, the modeling data may be acquired from historical datasets, be synthetically generated, or may be a combination of real and synthetic data. In Block 406, the modeling data is split into a training set, validation set, and test set. In one or more embodiments, the validation and the test set are the same such that the modeling data is effectively split into a training set and a validation/testing set. In Block 408, given the machine-learned model type (e.g., autoencoder) an architecture (e.g., number of layers, compression ratio, etc.) are selected. In accordance with one or more embodiments, architecture selection is performed by cycling through a set of user-defined architectures for a given model type. In other embodiments, the architecture is selected based on the performance of previously evaluated models with their associated architectures, for example, using a Bayesian-based search. In Block 410, with an architecture selected, the machine-learned model is trained using the training set. During training, the machine-learned model is adjusted such that the output of the machine-learned model, upon receiving an input, is similar to the associated target (or, in the case of an autoencoder, the input). Once the machine-learned model is trained, in Block 412, the validation set is processed by the trained machine-learned model and its outputs are compared to the associated targets. Thus, the performance of the trained machine-learned model can be evaluated. Block 414 represents a decision. If the trained machine-learned model is found to have suitable performance as evaluated on the validation set, where the criterion for suitable performance is defined by a user, then the trained machine-learned model is accepted for use in a production (or deployed) setting. As such, in Block 418, the trained machine-learned model is used in production. However, before the machine-learned model is used in production a final indication of its performance can be acquired by estimating the generalization error of the trained machine-learned model, as shown in Block 416. The generalization error is estimated by evaluating the performance of the trained machine-learned model, after a suitable model has been found, on the test set. One with ordinary skill in the art will recognize that the training procedure depicted in FIG. 4 is general and that many adaptations can be made without departing from the scope of the present disclosure. For example, common training techniques, such as early stopping, adaptive or scheduled learning rates, and cross-validation may be used during training without departing from the scope of this disclosure.

The results of the first and second assessments are stored in the data repository, to facilitate, both, the regular expression and machine learning-based assessments. By centralizing and organizing the textual evidence, the system may swiftly access and apply the relevant assessment method for each control.

Turning back to FIG. 2, in one or more embodiments, the second assessment of the cybersecurity data using a machine learning analysis generates the quantitative risk scores for various cybersecurity aspects, derived from machine learning models trained on historical data. Further, the second assessment generates classification results which categorize data into different classes (e.g., compliant, non-compliant) based on learned patterns. Additionally, predictive insights, generated by the second assessment, predict about future compliance status or potential security incidents based on current and historical data.

In Block 260, the cybersecurity compliance assessment manager (150) computes a compliance score based on the first assessment outputs and the second assessment outputs using a predefined algorithm. More specifically, the predefined algorithm computes the compliance score based on the weightage of different types of data and their relevance to compliance, the severity of detected issues and anomalies, and the historical compliance data and trends. The calculated score is normalized to a standardized scale (e.g., 0 to 100) for easy interpretation and comparison. Additionally, the compliance score is compared against predefined thresholds to determine the compliance status (e.g., compliant, partially compliant, non-compliant). This helps in identifying areas that need improvement.

In one or more embodiments, the system may perform the control mapping by aligning the security controls with one or more cybersecurity standards or frameworks. The control mapping process may include identifying requirements of the cybersecurity standards or frameworks and assessing cybersecurity controls such as firewalls, encryptions, control access policies, etc. The controls may be mapped to the requirements, to evaluate potential differences between controls and requirements in the system. As such, the goal of control mapping is to streamline and harmonize cybersecurity efforts, especially when an organization needs to comply with multiple cybersecurity standards, regulations, or frameworks. The control mapping helps ensuring that the organization's cybersecurity posture remains robust and meets the necessary requirements from various sources.

In Block 270, one or more remediation commands are transmitted based on a compliance score in accordance with one or more embodiments. In some embodiments, the cybersecurity compliance assessment manager (150) may perform remediation monitoring and/or remediation procedures over a network. More specifically, the cybersecurity compliance assessment manager (150) may track implementation of various remediation procedures, e.g., with a remediation queue, and determine the status of implementing a particular remediation procedure. For example, the cybersecurity compliance assessment manager (150) may schedule different remediation procedures for different times and in a predetermined sequence. For example, this schedule may be controlled and/or adjusted using remediation commands. In some embodiments, a remediation command is similar to the remediation commands described above in FIG. 1 and the accompanying description.

Accordingly, a network element may transmit remediation data to the cybersecurity compliance assessment manager (150). For example, remediation data may provide a status update regarding one or more remediation procedures being performed on the network element. Thus, in some embodiments, a remediation procedure is performed autonomously using a cybersecurity compliance assessment manager (150). Likewise, one or more compliance scores may be updated in response to determining completion of a remediation procedure. A cybersecurity maturity manager may further update a cybersecurity assessment of a network or network element without conducting a full assessment again based completion of the remediation procedure. The cybersecurity compliance assessment manager (150) may also conduct incremental assessment as required for specific control standards identified as a gap during the full assessment.

In some embodiments, hardware probes and/or software probes determine the compliance scores. Accordingly, a hardware probe and/or a software probe may determine remediation commands based on cybersecurity data at the corresponding probe without communication initially with a cybersecurity maturity manager. Thus, a hardware probe or a software probe may initiate a remediation procedure to increase a particular compliance score for one or more measurement domains within a network.

In one or more embodiments, the cybersecurity compliance assessment manager (150) generates a comprehensive report that provides valuable insights into the compliance status. The report is designed to offer a clear and detailed overview of the department's compliance level, highlighting areas of success and areas that require improvement. Additionally, the report includes specific recommendations for departments that do not satisfy the compliance requirements. The cybersecurity compliance assessment manager (150) may transmit an alert when the compliance score of one or more departments is below the predetermined threshold.

In one or more embodiments, the cybersecurity compliance assessment manager (150) may perform benchmarking among all departments. The benchmarking may enable organizations to compare the performance and compliance levels of different departments against each other and established standards. This feature empowers organizations to identify best practices, learn from top-performing departments, and set higher targets for compliance.

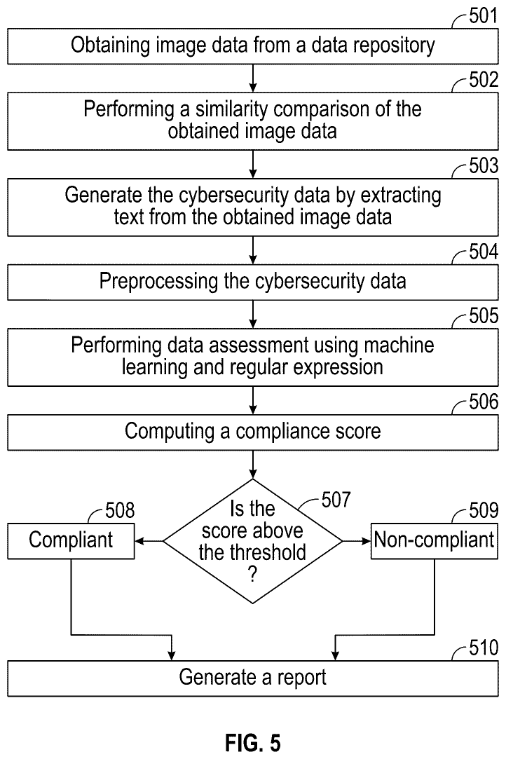

Turning to FIG. 5, FIG. 5 shows a flowchart in accordance with one or more embodiments. Specifically, FIG. 5 describes a specific method for assessing the compliance of the cybersecurity data. One or more blocks in FIG. 5 may be performed by one or more components (e.g., cybersecurity compliance assessment manager (150)) as described in FIG. 1. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 501, the image data is obtained and stored into the data repository (193). The image data may be periodically automatically collected by hardware and software probes. Additionally, the image data may be uploaded to the data repository by a cybersecurity system operator after completing a task or when evaluating a compliance of a part of the system or system in general.

In Block 502, the cybersecurity compliance assessment manager (150) performs various comparison techniques to ensure the integrity of compliance evaluations and prevent cheating. The system incorporates robust similarity checking mechanisms to compare new assessments against existing in the database. This involves employing hash comparison and pixel-level analysis for image-based evidence.

In hash comparison, unique cryptographic hashes are generated for each uploaded evidence, serving as digital fingerprints. These hashes are then compared with existing ones to detect potential duplicate or reused evidence across different departments. Additionally, pixel-level comparison analyzes the visual features of images, setting thresholds for acceptable similarities based on the assessment's nature. If an image exceeds the threshold for similarity with previously submitted ones, an alert is triggered, indicating potential evidence reuse or unauthorized sharing.

By combining hash comparison and pixel-level analysis, the system ensures a comprehensive similarity checking system, preserving the assessment process's integrity and fairness. This approach enables assessors to trust the system to detect misleading evidence, ensuring accurate evaluations for each department.

In Block 503, the algorithm engine (152) analyzes image data stored in the data repository (193), focusing on extracting cybersecurity data. This involves processing the image data to identify various forms of cybersecurity data, such as text (logs, reports, emails), numeric data (network traffic, performance metrics), metadata (timestamps, IP addresses), binary data, structured data, and unstructured data.

To extract cybersecurity data from the image data, the algorithm engine (152) employs cybersecurity data extraction functions. These functions may include optical character recognition, image processing, machine learning, template matching, handwriting recognition, barcodes, and QR codes. They are designed to analyze various types of content within images, including printed text, handwritten text, embedded text, templates, checklists, and numerical data.

In Block 504, as discussed previously, the algorithm engine (152) preprocesses the extracted cybersecurity data through various techniques, including noisy entity removal, tokenization, and lemmatization, and aim to refine the quality of the extracted text.

In Block 505, the cybersecurity compliance assessment manager (150) initiates an assessment of preprocessed cybersecurity data employing regular expression analysis. In some embodiments, this analysis may involve searching for specific patterns or sequences of characters or numbers within the text, commonly used to define patterns in emails, documents, or webpages. Once these patterns are identified, they may be validated against predetermined formulas to ensure data format consistency. The resulting text patterns are stored in the data repository for further use.

In one or more embodiments, the cybersecurity compliance assessment manager (150) may conduct an assessment of the preprocessed cybersecurity data using one or more machine learning models. These models utilize the patterns generated from the regular expression analysis. They are trained on relevant datasets to recognize patterns, relationships, and context within the text. Machine learning allows for a deeper understanding of context and variations, enabling effective evaluation of patterns that demand such comprehension.

In Block 506, the cybersecurity compliance assessment manager (150) computes the compliance score based on the first assessment outputs and the second assessment outputs using a predefined algorithm. More specifically, the predefined algorithm computes the compliance score based on the weightage of different types of data and their relevance to compliance, the severity of detected issues and anomalies, and the historical compliance data and trends.

In Block 507, a determination is made based on the computed compliance score. If the compliance score is bigger than a predetermined threshold the system is marked as compliant in Block 508. However, if the compliance score is smaller than a predetermined threshold the system is marked as non-compliant in Block 509.

In Block 510, the cybersecurity compliance assessment manager (150) creates a detailed report aimed at providing valuable insights into the compliance status. This report offers a clear overview of the department's compliance level by pointing out the successful areas and those needing improvement. It also includes specific recommendations for departments failing to meet compliance requirements. Additionally, the manager may transmit alerts if the compliance score of one or more departments falls below a predetermined threshold.

Embodiments may be implemented on any suitable computing device, such as the computer system shown in FIG. 6. Specifically, FIG. 6 is a block diagram of a computer system (600) used to provide computational functionalities associated with described algorithms, methods, functions, processes, flows, and procedures as described in the instant disclosure, according to an implementation. The illustrated computer (600) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (600) may include a computer that includes an input device, such as a keypad, keyboard, touch screen, or other device that can accept user information, and an output device that conveys information associated with the operation of the computer (600), including digital data, visual, or audio information (or a combination of information), or a GUI.

The computer (600) can serve in a role as a client, network component, a server, a database or other persistency, or any other component (or a combination of roles) of a computer system for performing the subject matter described in the instant disclosure. The illustrated computer (600) is communicably coupled with a network (610). In some implementations, one or more components of the computer (600) may be configured to operate within environments, including cloud-computing-based, local, global, or other environment (or a combination of environments).

At a high level, the computer (600) is an electronic computing device operable to receive, transmit, process, store, or manage data and information associated with the described subject matter. According to some implementations, the computer (600) may also include or be communicably coupled with an application server, e-mail server, web server, caching server, streaming data server, business intelligence (BI) server, or other server (or a combination of servers).

The computer (600) can receive requests over network (610) from a client application (for example, executing on another computer (600) and responding to the received requests by processing the said requests in an appropriate software application. In addition, requests may also be sent to the computer (600) from internal users (for example, from a command console or by other appropriate access method), external or third-parties, other automated applications, as well as any other appropriate entities, individuals, systems, or computers.

Each of the components of the computer (600) can communicate using a system bus (670). In some implementations, any or all of the components of the computer (600), both hardware or software (or a combination of hardware and software), may interface with each other or the interface (620) (or a combination of both) over the system bus (670) using an application programming interface (API) (640) or a service layer (660) (or a combination of the API (650) and service layer (660). The API (650) may include specifications for routines, data structures, and object classes. The API (650) may be either computer-language independent or dependent and refer to a complete interface, a single function, or even a set of APIs. The service layer (660) provides software services to the computer (600) or other components (whether or not illustrated) that are communicably coupled to the computer (600). The functionality of the computer (600) may be accessible for all service consumers using this service layer. Software services, such as those provided by the service layer (660), provide reusable, defined business functionalities through a defined interface. For example, the interface may be software written in JAVA, C++, or other suitable language providing data in extensible markup language (XML) format or other suitable format. While illustrated as an integrated component of the computer (600), alternative implementations may illustrate the API (650) or the service layer (660) as stand-alone components in relation to other components of the computer (600) or other components (whether or not illustrated) that are communicably coupled to the computer (600). Moreover, any or all parts of the API (650) or the service layer (660) may be implemented as child or sub-modules of another software module, enterprise application, or hardware module without departing from the scope of this disclosure.

The computer (600) includes an interface (620). Although illustrated as a single interface (620) in FIG. 6, two or more interfaces (620) may be used according to particular needs, desires, or particular implementations of the computer (600). The interface (620) is used by the computer (600) for communicating with other systems in a distributed environment that are connected to the network (610). Generally, the interface (620 includes logic encoded in software or hardware (or a combination of software and hardware) and operable to communicate with the network (610). More specifically, the interface (620) may include software supporting one or more communication protocols associated with communications such that the network (610) or interface's hardware is operable to communicate physical signals within and outside of the illustrated computer (600).

The computer (600) includes at least one computer processor (630). Although illustrated as a single computer processor (630) in FIG. 6, two or more processors may be used according to particular needs, desires, or particular implementations of the computer (600). Generally, the computer processor (630) executes instructions and manipulates data to perform the operations of the computer (600) and any algorithms, methods, functions, processes, flows, and procedures as described in the instant disclosure.

The computer (600) also includes a memory (680) that holds data for the computer (600) or other components (or a combination of both) that can be connected to the network (610). For example, memory (680) can be a database storing data consistent with this disclosure. Although illustrated as a single memory (680) in FIG. 6, two or more memories may be used according to particular needs, desires, or particular implementations of the computer (600) and the described functionality. While memory (680) is illustrated as an integral component of the computer (600), in alternative implementations, memory (680) can be external to the computer (600).

The application (640) is an algorithmic software engine providing functionality according to particular needs, desires, or particular implementations of the computer (600), particularly with respect to functionality described in this disclosure. For example, application (640) can serve as one or more components, modules, applications, etc. Further, although illustrated as a single application (640), the application (640) may be implemented as multiple applications (640) on the computer (600). In addition, although illustrated as integral to the computer (600), in alternative implementations, the application (640) can be external to the computer (600).

There may be any number of computers (600) associated with, or external to, a computer system containing computer (600), each computer (600) communicating over network (610). Further, the term “client,” “user,” and other appropriate terminology may be used interchangeably as appropriate without departing from the scope of this disclosure. Moreover, this disclosure contemplates that many users may use one computer (600), or that one user may use multiple computers (600).

In some embodiments, the computer (600) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method, comprising:
obtaining image data from a data repository;
performing, by a computer processor, a similarity comparison of the obtained image data using a plurality of comparison techniques;
extracting, by the computer processor, cybersecurity data from the obtained image data;
preprocessing, by the computer processor, the cybersecurity data using at least one preprocessing technique;
generating, by the computer processor, a first assessment of the preprocessed cybersecurity data using regular expression analysis;
generating, by the computer processor, a second assessment of the preprocessed cybersecurity data using a plurality of machine learning models;
computing, by the computer processor, a cybersecurity compliance score based on the first assessment and the second assessment; and
transmitting, by the computer processor and based on the cybersecurity compliance score, a remediation command configured to adjust at least one configuration setting of a network.

2. The method of claim 1, further comprising:
performing, by the computer processor, a control mapping of a plurality of system controls to cybersecurity standards
performing, by the computer processor, a benchmarking process between a plurality of cybersecurity systems.

3. The method of claim 1, wherein the plurality of comparison techniques includes a hash comparison and a pixel comparison.

4. The method of claim 3, wherein duplicate data and reused data is detected using the hash comparison.

5. The method of claim 1, wherein the at least one preprocessing technique includes noisy entity removal, tokenization, and lemmatization.

6. The method of claim 1, wherein a report is generated based on the first assessment and the second assessment.

7. The method of claim 2, wherein the remediation command is configured to adjust the at least one configuration setting of the network is transmitted when the compliance score is below a predetermined threshold.

8. A system, comprising:
a network comprising a plurality of network elements;
a hardware probe coupled to the plurality of network elements;
a network element coupled to the plurality of network elements, the network element comprising a software probe; and
a computer processor, wherein the computer processor is coupled to the hardware probe, the software probe, and the plurality of network elements, and wherein the computer processor comprises functionality for:
obtaining image data from a data repository;
performing a similarity comparison of the obtained image data using a plurality of comparison techniques;
extracting cybersecurity data from the obtained image data;
preprocessing the cybersecurity data using at least one preprocessing technique;
generating a first assessment of the preprocessed cybersecurity data using regular expression analysis;
generating a second assessment of the preprocessed cybersecurity data using a plurality of machine learning models;
computing a cybersecurity compliance score based on the first assessment and the second assessment; and
transmitting, based on the cybersecurity compliance score, a remediation command configured to adjust at least one configuration setting of the network.

9. The system of claim 8, wherein the computer processor further comprises functionality for:
performing a control mapping of a plurality of system controls to cybersecurity standards; and
performing a benchmarking process between a plurality of cybersecurity systems.

10. The system of claim 8, wherein the plurality of comparison techniques includes a hash comparison and a pixel comparison.

11. The system of claim 10, wherein duplicate data and reused data is detected using the hash comparison.

12. The system of claim 9, wherein the at least one preprocessing technique includes noisy entity removal, tokenization, and lemmatization.

13. The system of claim 9, wherein a report is generated based on the first assessment and the second assessment.

14. The system of claim 9, wherein the remediation command configured to adjust the at least one configuration setting of the network is transmitted when the compliance score is below a predetermined threshold.

15. A non-transitory computer readable medium storing instructions executable by a computer processor, the instructions comprising functionality for:
obtaining image data from a data repository;
performing a similarity comparison of the obtained image data using a plurality of comparison techniques;
extracting cybersecurity data from the obtained image data;
preprocessing the cybersecurity data using at least one preprocessing technique;
generating a first assessment of the preprocessed cybersecurity data using regular expression analysis;
generating a second assessment of the preprocessed cybersecurity data using a plurality of machine learning models;
computing a cybersecurity compliance score based on the first assessment and the second assessment; and
transmitting, based on the cybersecurity compliance score, a remediation command configured to adjust at least one configuration setting of a network.

16. The non-transitory computer readable medium of claim 15, wherein the instructions further comprise functionality for:
computing a compliance score based on the first assessment and the second assessment;
performing a control mapping of a plurality of system controls to cybersecurity standards; and
performing a benchmarking process between a plurality of cybersecurity systems.

17. The non-transitory computer readable medium of claim 15, wherein the plurality of comparison techniques includes a hash comparison and a pixel comparison.

18. The non-transitory computer readable medium of claim 17, wherein duplicate data and reused data is detected using the hash comparison.

19. The non-transitory computer readable medium of claim 15, wherein the at least one preprocessing technique include noisy entity removal, tokenization, and lemmatization.

20. The non-transitory computer readable medium of claim 15, wherein the remediation command configured to adjust the at least one configuration setting of the network is transmitted when the compliance score is below a predetermined threshold.
